(19) United States
(12) Patent Application Publication
(10) Pub. No.: US 2015/0362022 A1
(43) Pub. Date: Dec. 17, 2015

(54) ALUMINUM CLUTCH COMPONENTS WITH FERROUS SURFACES

(71) Applicant: GM Global Technology Operations LLC, Detroit, MI (US)

(72) Inventors: SCOTT W. HEITZENRATER, ORION, MI (US); MARY LAPRES-BILBREY, BRIGHTON, MI (US)

(21) Appl. No.: 14/703,330

(22) Filed: May 4, 2015

Related U.S. Application Data
(60) Provisional application No. 62/011,872, filed on Jun. 13, 2014.

(51) Int. Cl. F16D 13/70

(52) U.S. Cl. CPC F16D 13/70; F16D 2300/10

(57) ABSTRACT

Friction clutch components, such as apply plates, reaction plates and backing plates for motor vehicle automatic transmissions, fabricated according to the present invention, have reduced weight and improved service life. Apply plates and reaction plates are fabricated of aluminum coated with a thin layer of thermally sprayed steel or ferrous material. Backing plates are fabricated of powdered metal aluminum, stamped and machined aluminum, forged and machined aluminum or extruded aluminum and also coated with a thin layer of thermally sprayed steel or ferrous material. The thermally sprayed steel material may be a low carbon steel such as SAE 1008 or 1010 or a similar alloy. The plates are then finished by belt sanding, brushing or a similar surface finishing technique.

### CROSS REFERENCE TO RELATED APPLICATION

This application claims the benefit of U.S. Provisional Patent Application Ser. No. 62/011,872, filed Jun. 13, 2014, which is hereby incorporated in its entirety herein by reference.

### FIELD

The present disclosure relates to aluminum friction clutch components and more particularly to aluminum friction clutch components including a thin layer of steel or iron disposed on a surface.

### BACKGROUND

The statements in this section merely provide background information related to the present disclosure and may or may not constitute prior art.

A conventional friction clutch includes a friction clutch pack having alternating friction plates and reaction plates disposed between an apply plate which is acted upon by a compressive actuator or operator and a backing plate against which the friction clutch pack is compressed. When compressed, torque is transferred through the friction clutch pack between an inner hub with which the friction plates rotate and an outer housing with which the reaction plates rotate. Operation is similar in an inverted clutch configuration wherein friction plates are splined to the outer housing and reaction plates are splined to the inner hub.

These various components are typically fabricated of various steels due to the strength and durability this material provides. Not only does steel provide the structural integrity necessary to carry the torque loads encountered by such components but it also provides the durability of the faces or surfaces exposed to frictional (sliding) forces during clutch engagement.

While various steels provide the necessary strength and durability in this service, they are not without drawbacks. The primary contemporary issue with such steel clutch components is weight. Since these clutch components are both carried or translated as part of the total vehicle weight and rotate and thus contribute to powertrain energy loss as they are repeatedly accelerated, they twice contribute to fuel consumption. Accordingly, any weight reduction of a rotating component, such as a clutch component, positively affects fuel consumption both from the standpoint of total vehicle weight as well as powertrain efficiency.

A solution to the weight problem is the substitution of a lighter weight material such as aluminum. Aluminum has about one-third the density of steel and exhibits good heat transfer, both characteristics being important in clutch applications. However, it has been found that this material is unsuitable because the surfaces exposed to frictional (sliding) forces during clutch engagement exhibit unacceptable wear and thus unacceptably short service life.

### SUMMARY

The present invention provides friction clutch components, such as apply, reaction and backing plates, having reduced weight and improved service life. Apply plates and reaction plates are fabricated of aluminum coated with a thin layer of thermally sprayed steel or ferrous material. Backing plates are fabricated of powdered metal aluminum, stamped and machined aluminum, forged and machined aluminum or extruded aluminum and also coated with a thin layer of thermally sprayed steel or ferrous material. The thermally sprayed steel material may be a low carbon steel such as SAE 1008 or 1010 or a similar alloy. The plates are then finished by belt sanding, brushing or a similar surface finishing technique.

It is thus an aspect of the present invention to provide a friction clutch component fabricated of aluminum and having a thin layer of thermally sprayed steel material disposed on its friction faces.

It is a further aspect of the present invention to provide an apply plate for a friction clutch fabricated of aluminum and having a thin layer of thermally sprayed steel material disposed on its friction faces.

It is a still further aspect of the present invention to provide a reaction plate for a friction clutch fabricated of aluminum and having a thin layer of thermally sprayed steel material disposed on its friction faces.

It is a still further aspect of the present invention to provide a backing plate for a friction clutch fabricated of powdered metal aluminum, stamped and machined aluminum, forged and machined aluminum or extruded aluminum and having a thin layer of thermally sprayed steel material disposed on a friction face.

It is a still further aspect of the present invention to provide an apply plate for a friction clutch fabricated of aluminum and having a thin layer of thermally sprayed SAE 1008 or 1010 steel material disposed on its friction faces.

It is a still further aspect of the present invention to provide a reaction plate for a friction clutch fabricated of aluminum and having a thin layer of thermally sprayed SAE 1008 or 1010 steel or similar alloy material disposed on its friction faces.

It is a still further aspect of the present invention to provide a backing plate for a friction clutch fabricated of powdered metal aluminum, stamped and machined aluminum, forged and machined aluminum or extruded aluminum and having a thin layer of thermally sprayed SAE 1008 or 1010 steel material disposed on its friction face.

It is a still further aspect of the present invention to provide an apply plate for a friction clutch fabricated of aluminum and having a thin layer of belt sanded and brushed thermally sprayed SAE 1008 or 1010 steel or similar alloy material disposed on its friction faces.

It is a still further aspect of the present invention to provide a reaction plate for a friction clutch fabricated of aluminum and having a thin layer of belt sanded and brushed thermally sprayed SAE 1008 or 1010 steel or similar alloy material disposed on its friction faces.

It is a still further aspect of the present invention to provide a backing plate for a friction clutch fabricated of powdered metal aluminum and having a thin layer of belt sanded and brushed thermally sprayed SAE 1008 or 1010 steel or similar alloy material disposed on its friction face.

Further aspects, advantages and areas of applicability will become apparent from the description provided herein. It should be understood that the description and specific examples are intended for purposes of illustration only and are not intended to limit the scope of the present disclosure.

### DRAWINGS

The drawings described herein are for illustration purposes only and are not intended to limit the scope of the present disclosure in any way.

FIG. 1 is a fragmentary sectional view of a portion of an automatic transmission including a friction clutch pack having components including a thermally sprayed metal coating;

FIG. 2 is a sectional view of a portion of a friction clutch pack assembly including an apply plate, reaction plates and a backing plate including a thermally sprayed metal coating;

FIG. 3 is an enlarged fragmentary perspective view of an aluminum apply plate including thermally sprayed metal coatings on both faces according to the present invention;

FIG. 4 is an enlarged fragmentary perspective view of an aluminum reaction plate including thermally sprayed metal coatings on both faces according to the present invention;

FIG. 5 is an enlarged fragmentary perspective view of a powdered metal aluminum backing plate including a thermally sprayed metal coating on one face according to the present invention; and

FIG. 6 is a sectional view of a portion of an inverted friction clutch assembly including an apply plate, reaction plates and a backing plate including a thermally sprayed metal coating.

### DETAILED DESCRIPTION

The following description is merely exemplary in nature and is not intended to limit the present disclosure, application, or uses.

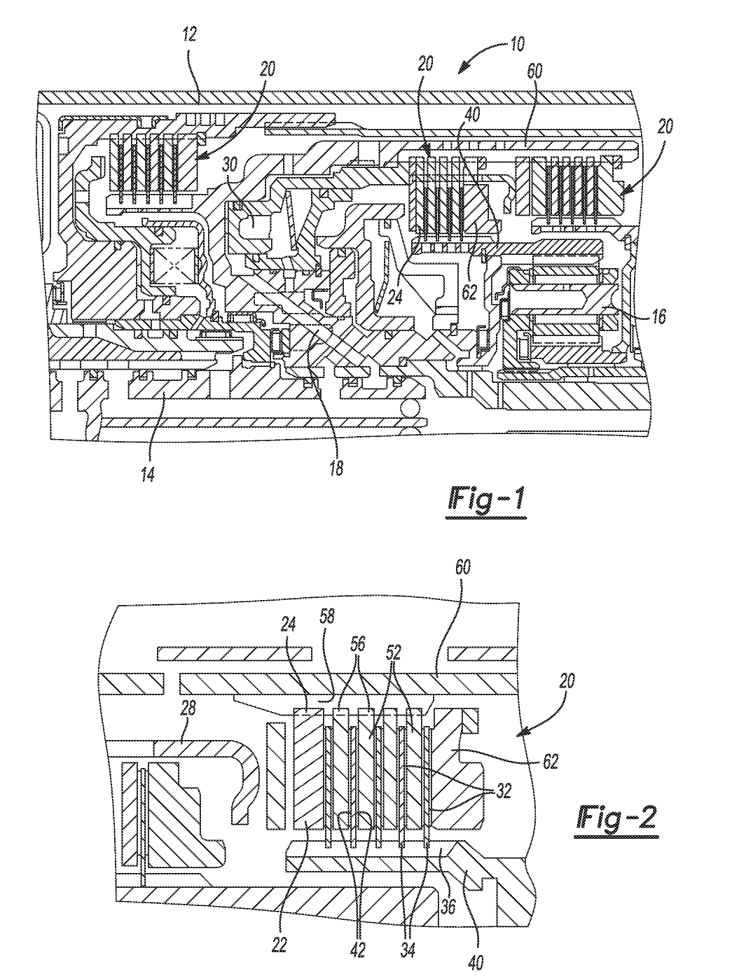

With reference to FIG. 1, a portion of a motor vehicle automatic transmission is illustrated and generally designated by the reference number 10. The automatic transmission 10 includes a housing 12 which mounts, positions and protects various components such as shafts and quills 14, a plurality of planetary gear assemblies 16, one of which is illustrated in FIG. 1, fluid passageways 18 and a plurality of friction clutch assemblies 20.

Referring now to FIGS. 1 and 2, the friction clutch pack assemblies 20 include an apply plate 22 having male splines 24 disposed about its periphery which engage a plurality of female splines 58 within an outer housing 60 and thus rotate therewith. The apply plate 22 is acted upon and axially translated by a linkage or member 28 driven by a hydraulic operator 30. The friction pack assemblies also include a plurality of first or friction plates or discs 32 having female splines 34 which engage complementary male splines 36 on an inner hub 40 and thus rotate therewith. The first or friction plates or discs 32 are conventional and include friction facing material 42 on both faces or surfaces. The plurality of first friction plates or discs 32 are interleaved with a plurality of second reaction plates or discs 52. The reaction plates or discs 52 include male splines 56 disposed about their peripheries which are complementary to and engage the plurality of female splines 58 within the outer housing 60 and thus rotate therewith. At the opposite end from the apply plate 22 is a backing plate 62 against which the friction plates 32 and reaction plates 52 are compressed by the hydraulic operator 30. When so compressed, torque is transmitted therebetween.

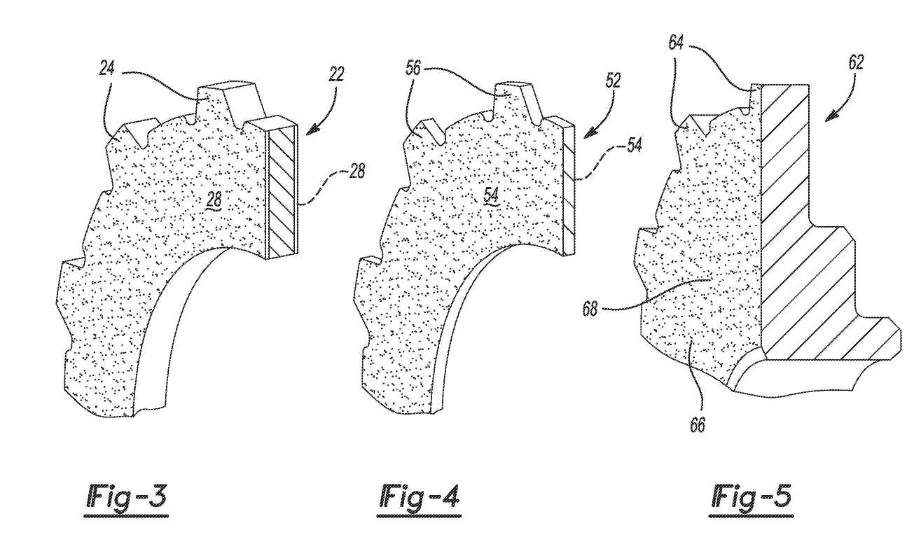

Referring now to FIG. 3, the apply plate 22 is fabricated of aluminum or an aluminum alloy and, as stated above, includes male splines 24 about its periphery. The entire front and rear faces or surfaces of the apply plate 22 include a thermally sprayed thin steel coating 28. Prior to thermal spray coating, the aluminum stock is preferably rolled and a textured surface is imparted by a pattern on the roller prior to stamping, the surface is belt sanded before or after stamping, a textured surface is imparted in the stamping process or the surface undergoes a similar treatment to provide an irregular surface finish which improves adherence of the sprayed thin steel coating 28. The thin steel coating is preferably SAE 1008 or 1010 steel but may be other alloys, compositions or other metals. The thin steel coating 28 on the faces is then belt sanded, brushed or undergoes similar surface treatment to improve its finish. The approximate finished thickness of the steel coating is 0.15 mm. (0.0059 inches) but may be thicker or thinner. The thermal spray process may be one of several similar processes, namely, high velocity oxygen fuel, powder plasma, plasma transferred wire arc or two wire arc.

Referring now to FIG. 4, the reaction plate or disc 52 is also fabricated of aluminum or an aluminum alloy and, as stated above, includes male splines 56 about its periphery. Typically, the reaction plate or disc 52 is between about 1.5 mm. to 3.0 mm. (0.059 to 0.118 inches) in thickness. The entire front and rear faces or surfaces of the reaction plate or disc 52 also include a thermally sprayed thin steel coating 54. Prior to thermal spray coating, the aluminum stock is also preferably rolled and a textured surface is imparted by a pattern on the roller prior to stamping, the surface is belt sanded before or after stamping, a textured surface is imparted in the stamping process or the surface undergoes a similar treatment to provide an irregular surface finish which improves adherence of the sprayed thin steel coating 54. The thin steel coating is preferably SAE 1008 or 1010 steel but may be other alloys, compositions or other metals. The thin steel coating 54 on the faces is then belt sanded, brushed or undergoes similar surface treatment to improve its finish. The approximate finished thickness of the steel coating is 0.15 mm. (0.0059 inches) but may be thicker or thinner. The thermal spray process may be one of several similar processes, namely, high velocity oxygen fuel, powder plasma, plasma transferred wire arc or two wire arc.

Referring now to FIG. 5, the backing plate 62 also includes male splines 64 which are complementary to and engage the female splines 58 within the outer housing 60 and thus it rotates with the outer housing 60. The backing plate 62 is preferably fabricated of powdered metal (PM) aluminum, stamped and machined aluminum, forged and machined aluminum or extruded aluminum. The entire front face or surface 66 of the backing plate 62 also includes a thermally sprayed thin steel coating 68. Preferably, the surface of the mold which forms the front face or surface 66 of the backing plate 62 is roughened or irregular so that it provides an irregular surface finish on the face or surface 66 which improves adherence of the sprayed thin steel coating 68. The thin steel coating is preferably SAE 1008 or 1010 steel but may be other alloys, compositions or other metals. The thin steel coating 68 on the face or surface 66 is then belt sanded, brushed or undergoes a similar treatment to improve the finish. The approximate finished thickness of the steel coating is 0.15 mm. (0.0059 inches) but may be thicker or thinner. The thermal spray process may be one of several similar processes, namely, high velocity oxygen fuel, powder plasma, plasma transferred wire arc or two wire arc.

Because the improved apply plates 22, the reaction plates 52 and the backing plates 62 according to the present invention replace or retrofit, both functionally and dimensionally, previously utilized components, they may be readily installed in place of such components. Thus, without requiring other engineering or design changes, the benefits they confer, primarily weight and energy savings, are immediately available. For example, in one eight speed transmission, substitution of just the apply plate 22 and the reaction plates 52 results in a weight saving of 2.4 Kg. (5.3 pounds).

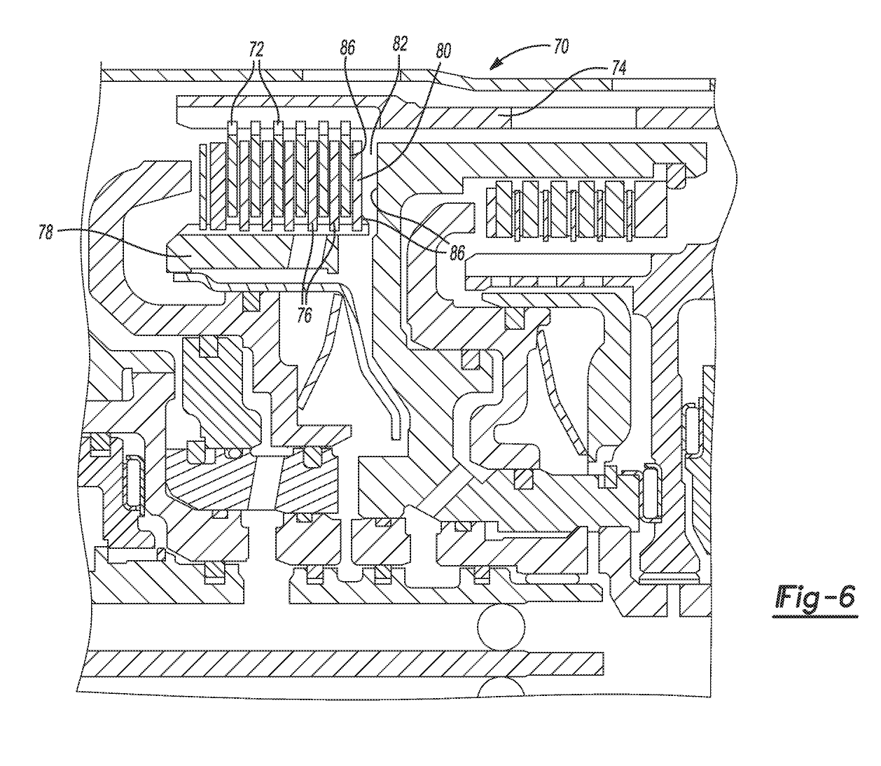

Referring now to FIG. 6, an inverted friction clutch assembly is illustrated and generally designated by the reference number 70. The inverted friction clutch assembly 70 is similar in many respects to the friction clutch pack assembly 20 illustrated in FIG. 2 except that the friction plates or discs 72 are splined to the outer housing 74 and rotate therewith and the interleaved reaction plates or discs 76 are splined to the inner hub 78 and rotate therewith. In the inverted clutch assembly 70, the backing plate 80 is usually another reaction plate 72 that is in place between the last friction plate 72 and the aluminum housing 82. In this configuration, either an aluminum reaction plate 72 or a backing plate 80 having a thin layer 86 of thermally sprayed SAE 1008 or 1010 steel or a similar alloy material disposed on its friction face may be utilized. Alternatively, the backing plate 80 can be omitted and the thin layer 86 of thermally sprayed SAE 1008 or 1010 steel or similar alloy material can be disposed on the friction face of the housing 82. In this case, the housing 82 actually serves the function of the backing plate 80.

The foregoing description of the invention is merely exemplary in nature and variations that do not depart from the gist of the invention are intended to be within the scope of the invention. Such variations are not to be regarded as a departure from the spirit and scope of the invention.

What is claimed is:

1. A component for a friction clutch pack assembly comprising, in combination,
a circular plate having a center opening, first and second side surfaces and inner and outer edges,
one of said inner and outer edges having a plurality of radially extending splines, and
said circular plate fabricated of aluminum and having a ferrous coating on said first and said second side surfaces.

2. The component for a friction clutch pack assembly of claim 1 wherein said circular plate is one of an apply plate and a reaction plate and said plurality of splines are disposed on said outer edge.

3. The component for a friction clutch pack assembly of claim 1 wherein said circular plate is one of an apply plate and a reaction plate and said plurality of splines are disposed on said inner edge.

4. The component for a friction clutch pack assembly of claim 1 wherein said circular plate is a backing plate fabricated of powdered aluminum and said plurality of splines are disposed on said outer edge.

5. The component for a friction clutch pack assembly of claim 1 wherein said ferrous coating is one of SAE 1008 steel, SAE 1010 steel and a steel alloy.

6. The component for a friction clutch pack assembly of claim 1 wherein said ferrous coating is a thermally sprayed coating.

7. The component for a friction clutch pack assembly of claim 1 wherein said first and said second side surfaces of said circular plate are textured and said ferrous coating is disposed on said textured surfaces.

8. A component for a friction clutch pack assembly comprising, in combination,
a circular apply plate having a center opening, first and second surfaces and inner and outer edges,
one of said inner and outer edges having a plurality of radially extending splines, and
said circular apply plate fabricated of aluminum and having a metal coating on said first and said second surfaces.

9. The component for a friction clutch pack assembly of claim 8 wherein said plurality of splines are disposed on said outer edge.

10. The component for a friction clutch pack assembly of claim 8 wherein said plurality of splines are disposed on said inner edge.

11. The component for a friction clutch pack assembly of claim 8 wherein said metal coating is one of SAE 1008 steel, SAE 1010 steel and a steel alloy.

12. The component for a friction clutch pack assembly of claim 8 wherein said metal coating is a thermally sprayed coating.

13. The component for a friction clutch pack assembly of claim 8 wherein said first and said second surfaces of said circular apply plate are textured and said metal coating is disposed on said textured surfaces.

14. A component for a friction clutch pack assembly comprising, in combination,
a circular reaction plate having a center opening, first and second surfaces and inner and outer edges,
one of said inner and outer edges having a plurality of radially extending splines, and
said circular apply plate fabricated of aluminum and having a metal coating on said first and said second surfaces.

15. The component for a friction clutch pack assembly of claim 14 wherein said plurality of splines are disposed on said outer edge.

16. The component for a friction clutch pack assembly of claim 14 wherein said plurality of splines are disposed on said inner edge.

17. The component for a friction clutch pack assembly of claim 14 wherein said metal coating is one of SAE 1008 steel, SAE 1010 steel and a steel alloy.

18. The component for a friction clutch pack assembly of claim 14 wherein said metal coating is a thermally sprayed coating.

19. The component for a friction clutch pack assembly of claim 14 wherein said first and said second surfaces of said circular reaction plate are textured and said metal coating is disposed on said textured surfaces.
